(19) United States
(12) Patent Application Publication
(10) Pub. No.: US 2014/0327615 A1
(43) Pub. Date: Nov. 6, 2014

(54) DISPLAY DEVICE AND INPUT CONTROL METHOD

(71) Applicant: FUJITSU LIMITED, Kawasaki-shi (JP)

(72) Inventor: Masakazu Watari, Inashiki (JP)

(73) Assignee: FUJITSU LIMITED, Kawasaki-shi (JP)

(21) Appl. No.: 14/243,355

(22) Filed: Apr. 2, 2014

(30) Foreign Application Priority Data
May 1, 2013 (JP) 2013-096374

(51) Int. Cl. G06F 3/041; G06F 3/0481

(52) U.S. Cl. CPC G06F 3/0416; G06F 3/04812
USPC 345/157

(57) ABSTRACT

A display device includes an obtainment unit configured to obtain a touch position and the number of touches on a screen; an input control unit configured to display a cursor at a relative position relative to the touch position obtained by the obtainment unit as a reference, and to control input using positional information of the cursor being displayed; and a change unit configured to switch the control executed by the input control unit if two touch positions including a first touch position and a second touch position are obtained by the obtainment unit, and to change the relative position by moving the second touch position relative to the first touch position.

### CROSS-REFERENCE TO RELATED APPLICATIONS

This application is based upon and claims the benefit of priority of the prior Japanese Priority Application No. 2013-096374 filed on May 1, 2013, the entire contents of which are hereby incorporated by reference.

### FIELD

The disclosures herein generally relate to a display device, an input control method, and an input control program.

### BACKGROUND

A touch user interface (touch UI) method is used for a tablet terminal, a smart phone, a personal computer (PC), and the like with which information is input by touching a screen of a display device. The display device receives a touch on a display screen (touch panel) as input from a user that is made with a finger or a pointing device such as a touch pen, and executes various input control.

In such a touch UI method described above, a cursor (also called a “guidance icon” or a “pointer”, for example) is displayed, for example, to clarify a position on the screen at which a user touches. For example, if the user slides a finger in a certain direction while keeping contact on the screen, the cursor moves along with movement of the finger of the user while maintaining a relative position with the touch position (see, for example, Patent Documents 1-2).

### RELATED-ART DOCUMENTS

### Patent Documents

[Patent Document 1] Japanese Laid-open Patent Publication No. 2003-186620
[Patent Document 2] Japanese Laid-open Patent Publication No. 2002-287904

For example, when changing a relative position of the displayed position of the cursor relative to a touch position of the finger, the relative position cannot be changed smoothly by a conventional method because an operation is required in which an initial setting screen or the like needs to be displayed before changing the relative position. Namely, such a conventional method requires the operation for the change, which is cumbersome and time-consuming.

### SUMMARY

According to at least an embodiment of the present invention, a display device includes an obtainment unit configured to obtain a touch position and the number of touches on a screen; an input control unit configured to display a cursor at a relative position relative to the touch position obtained by the obtainment unit as a reference, and to control input using positional information of the cursor being displayed; and a change unit configured to switch the control executed by the input control unit if two touch positions including a first touch position and a second touch position are obtained by the obtainment unit, and to change the relative position by moving the second touch position relative to the first touch position.

The object and advantages of the embodiment will be realized and attained by means of the elements and combinations particularly pointed out in the claims. It is to be understood that both the foregoing general description and the following detailed description are exemplary and explanatory and are not restrictive of the invention as claimed.

### BRIEF DESCRIPTION OF DRAWINGS

FIG. 1 is a schematic view illustrating an example of an appearance of a display device according to an embodiment of the present invention;

FIG. 2 is a schematic view illustrating an example of a hardware configuration of a display device according to an embodiment of the present invention;

FIG. 3 is a schematic view illustrating an example of a functional configuration of a display device according to an embodiment of the present invention;

FIGS. 4A-4C are schematic views illustrating an example of a cursor operation in a cursor operation mode according to an embodiment of the present invention;

FIG. 5 is a schematic view illustrating an example of a relative position according to an embodiment of the present invention;

FIGS. 6A-6C are schematic views illustrating a first example of a relative position change operation according to an embodiment of the present invention;

FIGS. 7A-7C are schematic views illustrating a second example of a relative position change operation according to an embodiment of the present invention;

FIG. 8 is a flowchart illustrating an example of an input control procedure according to an embodiment of the present invention;

FIG. 9 is a flowchart illustrating an example of a relative position change procedure according to an embodiment of the present invention;

FIG. 10 is a flowchart illustrating an example of a cursor icon change procedure according to an embodiment of the present invention; and

FIGS. 11A-11C are schematic views illustrating a state of a change of a cursor icon according to an embodiment of the present invention.

### DESCRIPTION OF EMBODIMENTS

In the following, embodiments of the present invention will be described with reference to the accompanying drawings.

<Example of Appearance and Hardware Configuration of Display Device in Present Embodiment>

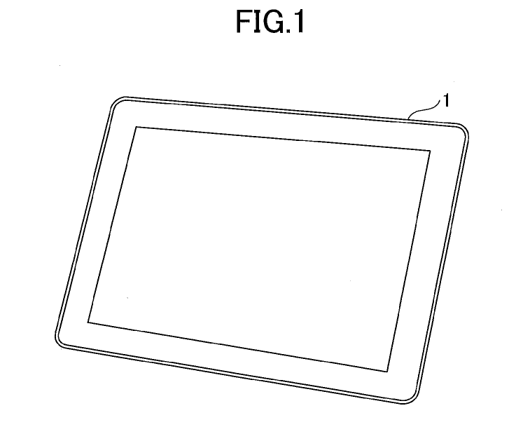

FIG. 1 is a schematic view illustrating an example of an appearance of a display device according to an embodiment of the present invention. The example in FIG. 1 illustrates a tablet terminal as an example of the display device 1 according to the present embodiment. A touch panel display is adopted for the screen of the display device 1.

When receiving a touch operation on the screen made by a user with a finger or the like, the display device 1 obtains input information such as a touch position, the number of touches, a movement direction of the finger, and the like. At this moment, the display device 1 displays a cursor on the screen as described above to explicitly indicate the position on the screen designated by the touch to the user.

The display device 1 executes various input control such as selection and movement of an icon and a button displayed on the touch panel, selection of an input area such as a check box, a text box, or the like, and character input, depending on the obtained input information.

The display device 1 may have operation buttons for turning the power on or off, adjusting volume of sound output from a loudspeaker or the like, inputting characters, and the like. The user can display the cursor on the screen by performing a predetermined operation on the screen or pushing the operation buttons described above.

The display device 1 in the present embodiment can be used for not only a tablet terminal as illustrated in FIG. 1, but also for information processing apparatuses, for example, a smart phone, a personal digital assistant (PDA), and an electronic board (electronic blackboard and the like). The display device 1 can also be used for other information processing apparatuses, for example, a PC, a server, a game device, a music player, and the like.

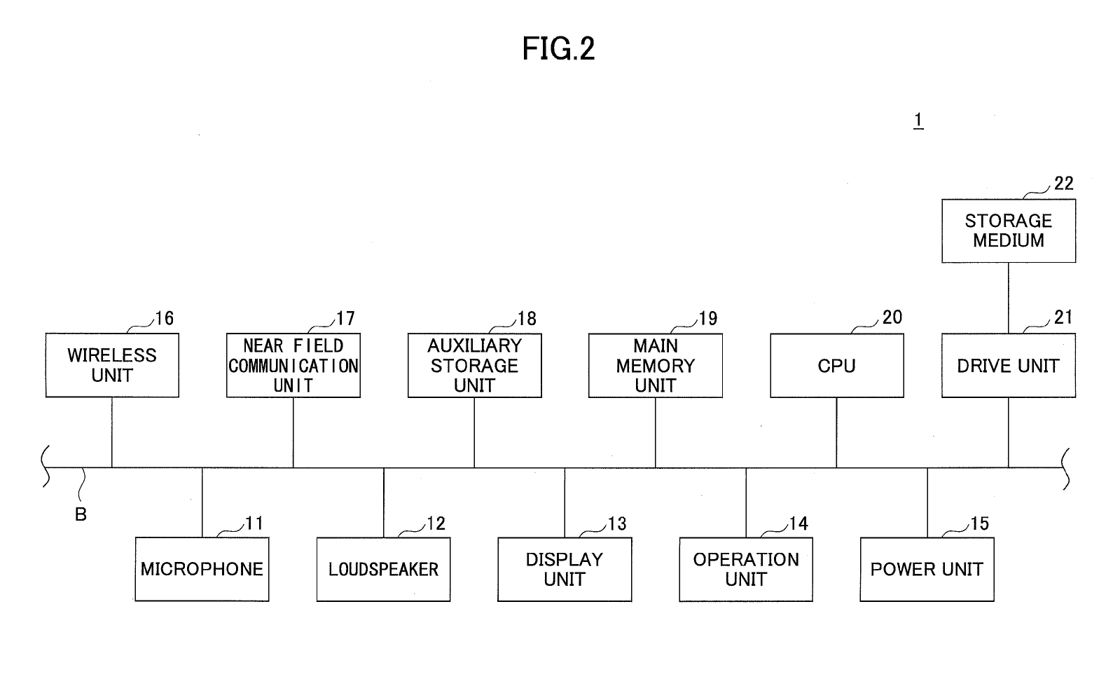

FIG. 2 is a schematic view illustrating an example of a hardware configuration of the display device 1 according to the present embodiment. In the example in FIG. 2, the display device 1 includes a microphone 11, a loudspeaker 12, a display unit 13, an operation unit 14, a power unit 15, a wireless unit 16, a near-field communication unit 17, an auxiliary storage unit 18, a main memory unit 19, a central processing unit (CPU) 20, and a drive unit 21, which are mutually connected by a system bus B.

The microphone 11 receives a voice uttered by a user or other sound as input. The loudspeaker outputs a voice of a phone call partner, an incoming-call sound, and the like. The microphone 11 and the loudspeaker 12 are used, for example, when making a conversation with a phone call partner using a phone call function or the like.

The display unit 13 is a display, for example, a liquid crystal display (LCD) or an organic electro luminescence (EL) display. Also, the display unit 13 may be a touch panel display that includes, for example, a display and a touch panel.

The operation unit 14 includes operation buttons, a touch panel, and the like. The operation buttons includes, for example, a power button, a volume adjustment button, and other operation buttons (for example, an end button, which will be described later). Also, the touch panel constitutes a touch panel display that superposes a display and the touch panel. Also, the type of the touch panel may be, for example, a resistive film type, an electrostatic capacitance type, an optical type, an electromagnetic induction type, or the like. Any of the types can be adopted as long as it has a sampling rate and a resolution sufficient for performing, for example, touch inputs on a software keyboard.

The power unit 15 supplies electric power to the elements of the display device 1. The power unit 15 is, for example, a built-in power source such as a battery, but not limited to that. The power unit 15 may detect a consumed amount of power always or at predetermined time intervals, and may monitor the remaining amount of power or the like.

The wireless unit 16 is a transmission/reception unit that receives a radio signal (communication data) from a base station using, for example, an antenna, and transmits a radio signal to the base station via the antenna.

The near-field communication unit 17 executes near-field communication with an external device using a communication method such as infrared communication, Bluetooth (trademark), or the like.

The wireless unit 16 and the near-field communication unit 17 described above are communication interfaces that make it possible to transmit and receive data with external devices.

The auxiliary storage unit 18 is a storage unit, for example, a hard disk drive (HDD) or a solid state drive (SSD). The auxiliary storage unit 18 stores various programs and the like, and inputs and outputs data when necessary.

The main memory unit 19 stores an execution program read from the auxiliary storage unit 18 following a command from the CPU 20, and stores various information obtained during program execution. The main memory unit 19 includes, for example, a read-only memory (ROM), a random access Memory (RAM), and the like, but not limited to these.

The CPU 20 executes various calculations and input/output of data between the hardware units based on a control program such as an operating system (OS) and an execution program stored in the main memory unit 19, and controls processing on a computer as a whole to implement procedures required for display the screen. Note that various information required for program execution may be obtained from the auxiliary storage unit 18, and an execution result or the like may be stored in the auxiliary storage unit 18.

The drive unit 21 can mount or unmount a storage medium 22, read various information stored in a mounted storage medium 22, and write predetermined information to the storage medium 22. The drive unit 21 may be realized as, for example, a slot for mounting a medium, but not limited to that.

The storage medium 22 is a storage medium to store the execution program and the like described above, which is readable on the computer. The storage medium 22 may be, for example, a semiconductor memory such as a flash memory. Also, the storage medium 22 may be a portable storage medium such as a Universal Serial Bus (USB) memory, but not limited to that.

By installing the execution program (for example, an input control program or the like) on the display device 1 configured as above, the hardware resources and software cooperate to implement display processes and the like in the present embodiment. Also, the input control program relating to the display processes described above may be resident on the display device 1 or loaded on demand.

The display device 1 described above may be implemented, for example, as a device that has a touch panel display built in, which is combined with a display unit, and software operating on the device. The software part may be replaced with hardware having equivalent functions.

<Example of Functional Configuration of Display Device 1 in Present Embodiment>

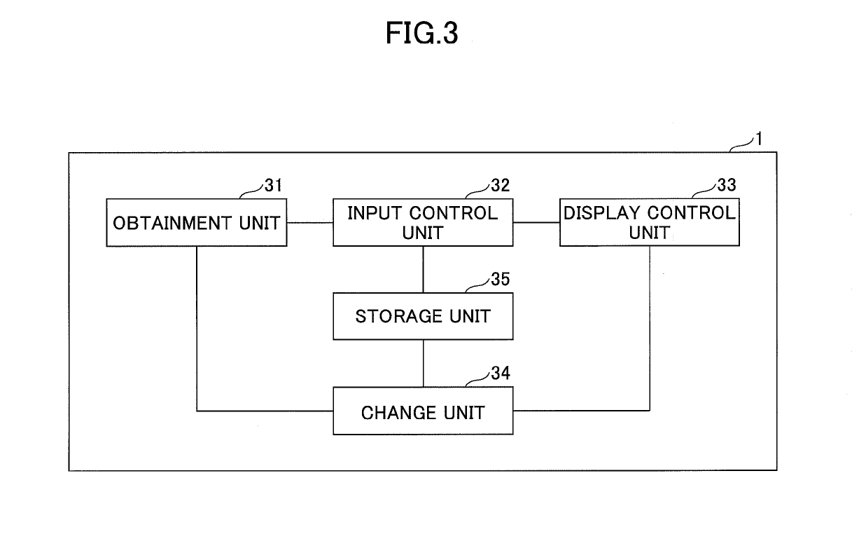

FIG. 3 is a schematic view illustrating an example of a functional configuration of the display device 1 according to the present embodiment. The display device 1 illustrated in FIG. 3 includes an obtainment unit 31, an input control unit 32, a display control unit 33, a change unit 34, and a storage unit 35.

The obtainment unit 31 receives various operations made on the touch panel screen (for example, a touch) as input from a user. For example, the obtainment unit 31 detects a contact point at which the screen is touched, and obtains positional coordinates of the contact point as operational point coordinates. Further, the obtainment unit 31 can obtain not only the touch position on the screen but also the number of touches. For example, the obtainment unit 31 may have a multi-touch UI that detects multiple contact points at the same time and obtain their respective operational point coordinates.

Further, the obtainment unit 31 may obtain operational point coordinates continuously following a slide operation (also called “swiping” or “dragging”, for example). The slide operation is an operation in which a user moves a finger from a position to another position on the touch panel while keeping contact on the touch panel. Therefore, the operational point coordinates obtained by the obtainment unit 31 keep on changing while predetermined sampling time intervals pass. The input control unit 32 executes input control for various operations made by the user based on the operational point coordinates obtained by the obtainment unit 31. For example, if the user makes a touch operation on a button displayed on the screen, the input control unit 32 compares the positional coordinates of the button with the operational point coordinates, and if the positional coordinates of the button is overlapped with the operational point coordinates, then determines that the button has been operated, and executes a process for the button push.

Note that the display device 1 in the present embodiment has an operation mode in which the cursor described above is displayed to enable operations using the cursor (called, for example, the “cursor operation mode”). Note that the cursor may not be displayed on the screen of the display device in a usual operational state. In that case the display device 1 receives a predetermined operation as input from the user for enabling operations using the cursor, and transitions into the cursor operation mode when detecting the input of the predetermined operation.

Once transitioned into the cursor operation mode, the input control unit 32 controls the cursor so that it is positioned at a relative position with respect to the touch position as a reference position where the relative position has been stored in the storage unit 35 or the like. Also, if the touch position is moved by the slide operation or the like, the input control unit 32 moves the cursor while keeping the relative position of the cursor position relative to the touch position.

Further, the input control unit 32 executes control of process switching for a process to change the relative position depending on the touch position and the number of touches that are obtained by the obtainment unit 31, and a process to change an icon of the cursor.

The display control unit 33 also controls content displayed on the screen of the touch panel such as icons and buttons to be displayed, positions and shapes of input areas and the like, and their sizes and colors. The display control unit 33 also controls the size, color, shape, and the like of the cursor described above, but is not limited to these.

The change unit 34 changes the relative positions of the cursor position relative to a touch position based on the predetermined operation made by the user. For example, if receiving an operation in which the cursor is moved while the touch position is fixed, the change unit 34 changes the relative position stored in the storage unit 35 to a relative position of the cursor position after movement relative to the touch position. Further, the change unit 34 may change the size, color, shape, and the like of the cursor to be displayed.

The storage unit 35 stores the relative position of the cursor position relative to the touch position, but information stored in the storage unit 35 is not limited to that. For example, the storage unit 35 may store information about an initial display position of the cursor at which the cursor is displayed soon after transitioned into the cursor operation mode. Also, the storage unit 35 may store information about the shape, color, size, and the like of the currently used cursor, and the information about multiple cursor icons (images) among which the user can make a selection of an icon.

The information stored in the storage unit 35 is read, for example, in the cursor operation mode, and updated when the relative position, shape, or the like of the cursor is changed. The storage unit 35 may be implemented by a non-volatile memory, for example, the auxiliary storage unit 18.

Note that the input control procedures in the present embodiment are implemented by installing the execution program (the input control program) on the display device 1 that has the CPU 20 and the like execute the functions described above.

<Example of Cursor Operation in Cursor Operation Mode>

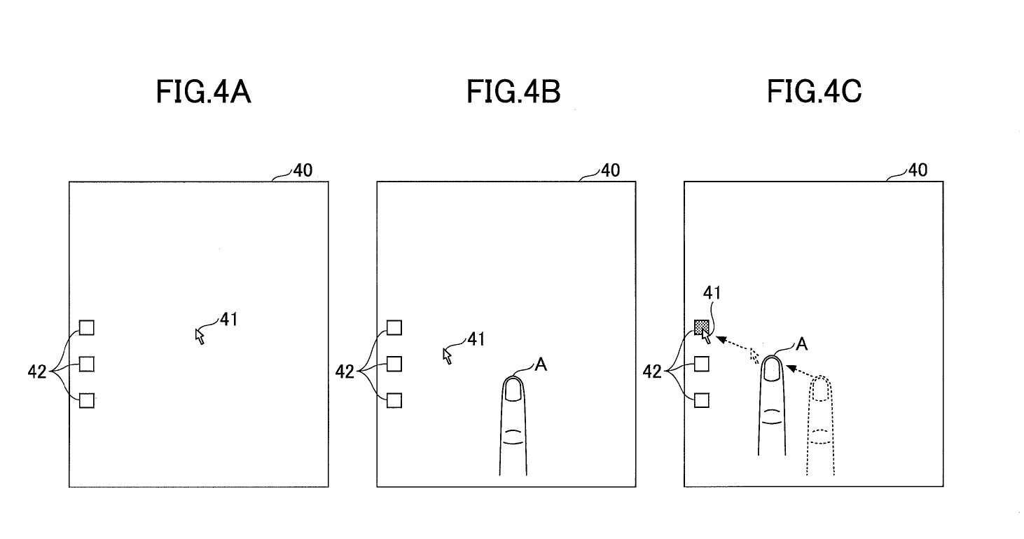

FIGS. 4A-4C are schematic views illustrating an example of a cursor operation in the cursor operation mode according to the present embodiment. First, the user has the display device 1 transition into the cursor operation mode by performing a predetermined operation if the user desires to use the cursor for operations.

Soon after transitioning into the cursor operation mode, the display device 1 displays the cursor 41 at an initial display position of a cursor on the touch panel (display screen) 40, for example, around the center position of the screen as illustrated in FIG. 4A. Note that buttons 42 are placed along the left edge of the touch panel 40 on which the user wants to operate using the cursor 41.

Next, when the user touches an arbitrary position on the touch panel 40 with a finger A, the display device 1 moves the display position of the cursor 41 to a position that is the relative position of the cursor relative to the touch position of the finger A as illustrated in FIG. 4B.

Here, the user slides the finger A in the left direction while keeping the finger A in contact, to operate on one of the buttons 42 using the cursor on the touch panel 40 as illustrated in FIG. 4C. The display device 1 moves the display position of the cursor 41 along with the movement of the moving finger A while keeping the relative position relative to the touch position of the finger A. Namely, when the user slides the finger A in the left upper direction while keeping the finger A in contact on the touch panel 40 as illustrated in FIG. 4C, the user can move the cursor 41 as the cursor 41 also slides in sync with the sliding movement of the finger A.

Note that, when the cursor 41 moves and reaches the button 42, the button 42 transitions into a state where pushing down can be executed. If the user performs, for example, tapping with the finger A in this state, the display device 1 receives the tapping as a command to execute input control for a push down of the selected button 42.

In this way, an input operation using the cursor 41 is based on the display position of the cursor 41 as an operation point, rather than the touch position of a finger. Namely, the user can avoid an erroneous input operation in the cursor operation mode because an input position is not hidden by the fingers and the like of the user when performing a position-sensitive input operation such as a push on a small button, for example, on the button 42. Note that the user can perform operations other than the one described above in the cursor operation mode.

<Example of Relative Position in Present Embodiment>

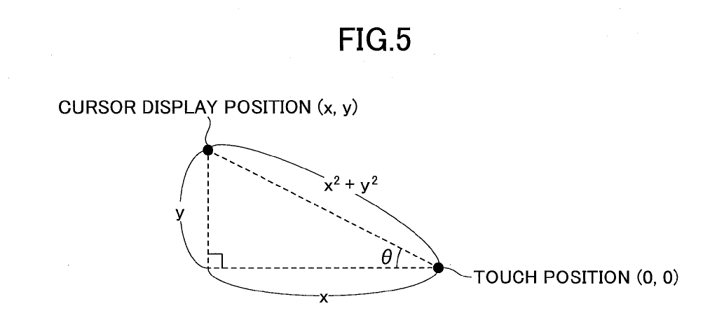

Here, the relative position in the present embodiment will be described using FIG. 5. FIG. 5 is a schematic view illustrating an example of a relative position according to the present embodiment. As illustrated in FIG. 5, the relative position in the present embodiment is constituted with components of a relative distance and a relative direction (relative angle) of a display position of the cursor relative to a touch position on the screen touched with a finger, a touch pen or the like as a reference position. Alternatively, it may be represented by orthogonal coordinates with which a relative position can be specified as (x, y) assuming that the touch position is at (0, 0). Directly following the above definition, the relative position is specified by the relative distance (for example, x²+y²) and the relative direction (for example, angle θ).

Note that component values of a relative position are kept unchanged unless a relative position change operation is executed, which will be described later. This makes the display position of the cursor 41 move along with the movement of a moving finger while keeping the relative position relative to the touch position of the finger.

<Example of Relative Position Change Operation in Cursor Operation Mode>

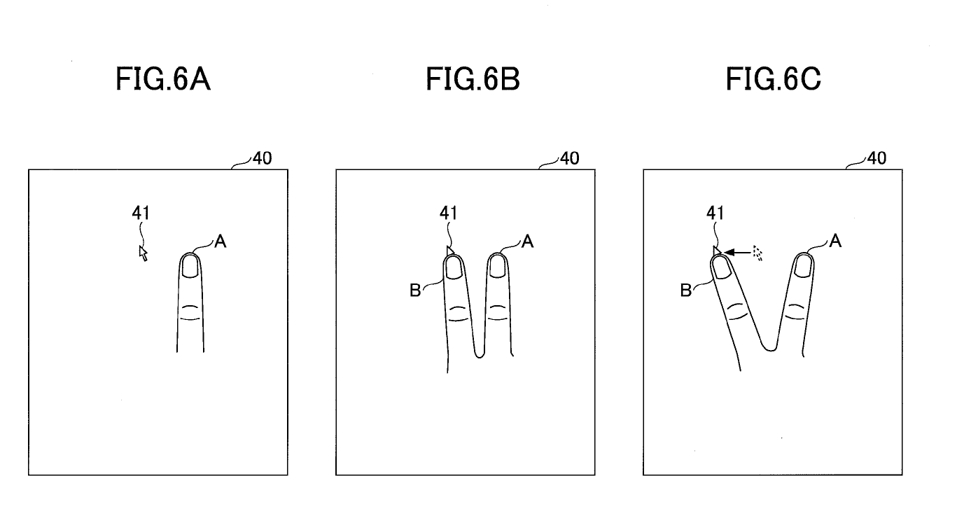

Next, examples of the relative position change operation in the cursor operation mode will be described using FIGS. 6A-6C.

### FIRST EXAMPLE OF CHANGE OPERATION

FIGS. 6A-6C are schematic views illustrating a first example of the relative position change operation according to the present embodiment. In the cursor operation mode, the user first touches an arbitrary position on the touch panel 40 with the finger A as illustrated in FIG. 6A. Detecting the touch of the finger A, the display device 1 obtains the touch position, and displays the cursor 41 at a position, which is the relative position (referred to as “a” below) of the cursor 41 relative to the obtained touch position of the finger A.

Also, when the user slides the finger A while keeping contact on the touch panel 40, the display device 1 obtains the moving touch position at each predetermined time interval or predetermined movement amount. Further, the display device 1 moves the cursor 41 displayed on the touch panel 40 following the movement of the moving finger A while keeping the relative position “a” relative to the touch position of the finger A.

If the user wants to perform a change operation of the relative position “a”, the user touches the touch panel 40 using another finger B, which is different from the finger A. Note that it is preferable that the finger B touches the cursor 41 displayed on the touch panel 40 or a neighboring position around the cursor 41 as illustrated in FIG. 6B, but not limited to these. The display device 1 obtains the touch position of the finger A (first touch position), the touch position of the finger B (second touch position), and the number of touches (two in this case).

Next, the user fixes the finger A on the touch panel 40 and slides the finger B while keeping contact. Specifically, the user fixes the finger A as illustrated in FIG. 6C, and slides the finger B in the direction designated by an arrow so that the width between the fingers A and B becomes greater.

This makes the display device 1 move the cursor 41 to a different position along with the slide movement of the finger B. Consequently, the relative position of the display position of the cursor 41 relative to the touch position of the finger A is changed from the relative position “a” illustrated in FIG. 6A to the relative position illustrated in FIG. 6C (referred to as the relative position “b” below).

After that, if the user lifts the fingers A and B off the touch panel 40 or makes a double tap on the touch panel 40 using the finger A or B, the display device 1 fixes the relative position of the display position of the cursor 41 relative to the touch position of the finger A. In this way, the relative position “a” is changed to the new relative position “b”. The relative position “b” after the change is stored (overwritten and saved) in the storage unit 35.

Note that, in the first example of the change operation described above, the relative position of the display position of the cursor 41 relative to the touch position of the finger A may be changed in another way, for example, by sliding the finger B while having the finger A fixed so that the width between the fingers A and B becomes less.

Note also that, in the first example of the change operation described above, although the user slides the finger B horizontally to change the relative position of the cursor position relative to the touch position, it is not limited to that. Alternatively, the user may slide the finger B vertically, or in any other direction relative to the touch position of the finger A as the reference position.

### SECOND EXAMPLE OF CHANGE OPERATION

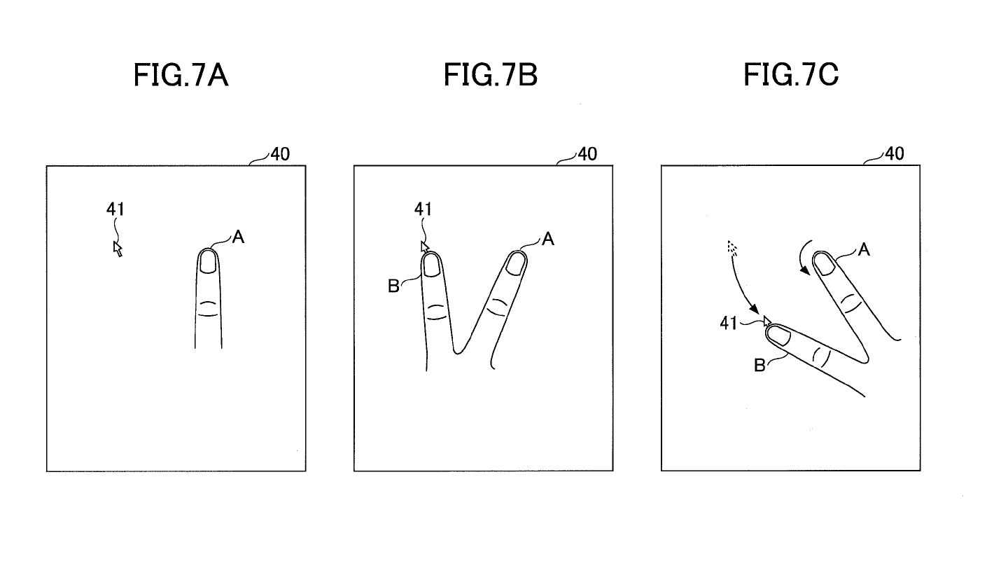

FIGS. 7A-7C are schematic views illustrating a second example of the relative position change operation according to the present embodiment. Note that, in the example in FIGS. 7A-7C, it is assumed that the relative position has been changed from “a” to “b” by the operation described in the first example of the change operation above.

In the cursor operation mode, the user first touches an arbitrary position on the touch panel 40 with the finger A as illustrated in FIG. 7A. Detecting the touch of the finger A, the display device 1 obtains the touch position, and displays the cursor 41 at a position that is the relative position “b” of the cursor 41 relative to the obtained touch position of the finger A.

If the user wants to perform a change operation of the relative position “b”, the user touches the touch panel 40 using another finger B, which is different from the finger A. Note that it is preferable that the finger B touches the cursor 41 displayed on the touch panel 40 or a neighboring position around the cursor 41 as illustrated in FIG. 7B, but is not limited to these. The display device 1 obtains the touch positions of the fingers A and B.

Next, the user slides and rotates the finger B around the finger A as the rotational axis as illustrated in FIG. 7C.

This makes the display device 1 move the cursor 41 to a different position along with the slide movement of the finger B. Consequently, the relative position of the display position of the cursor 41 relative to the touch position of the finger A is changed from the relative position “b” illustrated in FIG. 7A to the relative position illustrated in FIG. 7C (referred to as the relative position “c” below).

After that, if the user lifts the fingers A and B off the touch panel 40 or makes a double tap on the touch panel 40 using the finger A or B, the display device 1 fixes the relative position of the display position of the cursor 41 relative to the touch position of the finger A. In this way, the relative position “b” is changed to the new relative position “c”. The relative position “c” after the change is stored (overwritten and saved) in the storage unit 35.

As described above, the relative distance of the display position of the cursor 41 relative to the touch position of the finger A is changed in the first example of the change operation, whereas the relative direction (relative angle) of the display position of the cursor 41 relative to the touch position of the finger A is changed in the second example of the change operation. In the present embodiment, by performing the operations of the first and second examples as a set of operations at the same time, it is possible to simultaneously change the relative position and direction of the display position of the cursor 41 relative to the touch position of the finger A.

<Example of Input Control Procedure in Cursor Operation Mode>

Next, an input control procedure in the cursor operation mode will be described. Note that, in the input control procedure in the cursor operation mode, operational point coordinates, display coordinates, reference positional coordinates, and input coordinates are used.

The operational point coordinates are coordinates that represent the position of a contact point on the touch panel of a touch operation made by the user. Note that multiple operational point coordinates may be obtained (for example, operational point coordinates 1, operational point coordinates 2, and so on) because the display device 1 has a multi-touch UI. The display coordinates are coordinates that represent the display position of the cursor 41. The cursor 41 is displayed at the position specified by the display coordinates.

The reference positional coordinates are coordinates that represent a fixed position used as the reference position for calculating a relative position when performing a change operation of the relative position. The relative position is calculated based on the relative distance and direction between the reference position and the cursor position. The input coordinates are coordinates that represent a position where an input operation is made on the display device 1. Note that the display coordinates (positional coordinates) of the cursor is taken as the input coordinates in the cursor operation mode because the cursor designates an input position. In a usual operation state, alternatively, the operational point coordinates are taken as the input coordinates because a touch input of a finger designates an input position.

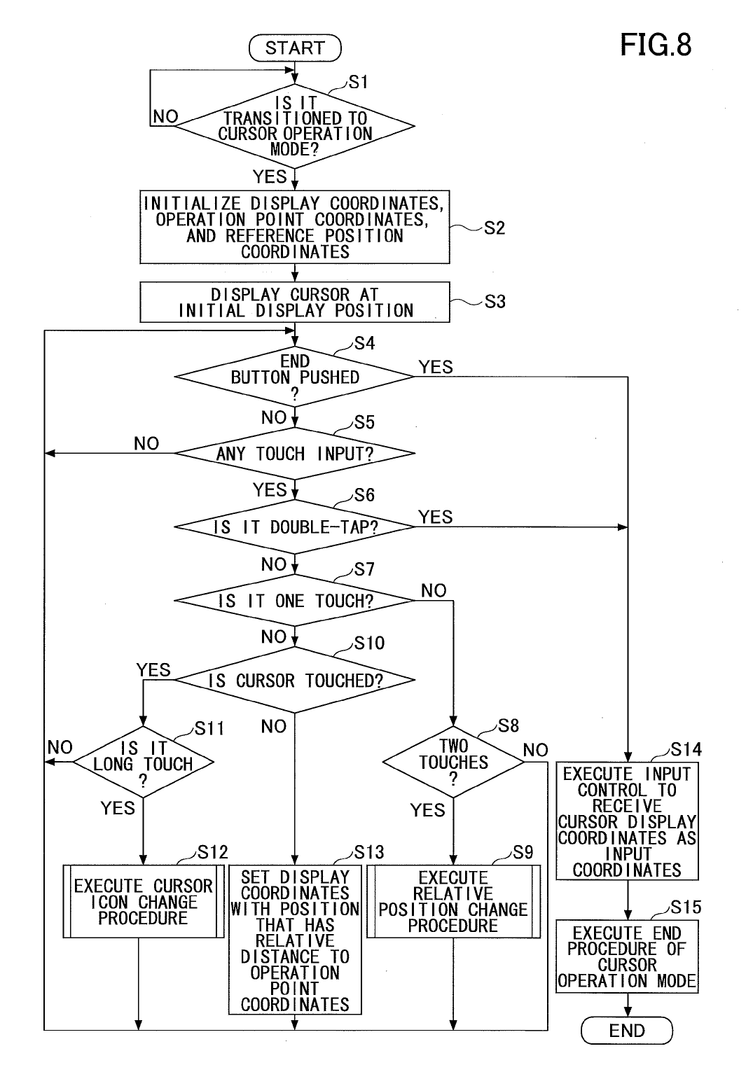

FIG. 8 is a schematic view illustrating an example of the input control procedure according to the present embodiment. In the example in FIG. 8, the input control unit 32 of the display device 1 determines whether the mode is transitioned into the cursor operation mode (Step S1). On the touch panel of a device that adopts a touch UI, for example, a tablet terminal or a smart phone, it is often the case that a cursor is not displayed in a usual operational state. Assuming the above, the display device 1 receives the predetermined operation as input from the user to transition into the cursor operation mode.

At Step S1, if determining that the mode has not transitioned into the cursor operation mode (NO at Step S1), the input control unit 32 of the display device 1 goes back to Step S1, and waits for a transition into the cursor operation mode. If determining that the mode has transitioned into the cursor operation mode (YES at Step S1), the input control unit 32 of the display device 1 initializes the display coordinates, the operational point coordinates, and the reference positional coordinates. Next, the display control unit 33 of the display device 1 displays the cursor at the initial display position (Step S3). At Step S3, by setting the initial values of the display coordinates to, for example, the center position of the screen, the cursor is displayed at the center position of the screen soon after transitioning into the cursor operation mode (see, for example, FIG. 4A).

Next, the input control unit 32 of the display device 1 determines whether an end button, which is set beforehand, is pushed down for ending the cursor operation mode (Step S4). The end button may be provided as, for example, at least one of the hardware keys (operation buttons) and the like of the display device 1, but not limited to that. It may be provided as a software button on the screen.

At Step S4, if determining that the end button is not pushed down (NO at Step S4), the input control unit 32 of the display device 1 determines whether there is a touch input on the touch panel made by the user (Step S5). For example, if there is a touch input on the touch panel made by the user, the obtainment unit 31 detects the contact point of the touch to obtain the positional coordinates (operational point coordinates) of the contact point. Therefore, the input control unit 32 can determine that a touch has been made if the obtainment unit 31 obtains the positional coordinates of the contact point.

At Step S5, if determining that a touch input has been made (YES at Step S5), the input control unit 32 of the display device 1 determines whether it is a double tap (Step S6). The input control unit 32 may determine that the touch input is a double tap if the obtainment unit 31 obtains operational point coordinates twice within a predetermined length of time. Note that a double tap is an example of an operation to end the cursor operation mode, which has the same effect as a pushing down of the end button. Therefore, at S6, the cursor operation mode may be ended with a detection of another operation for ending the cursor operation mode.

If determining that the touch input is not a double tap (NO at Step S6), the input control unit of the display device 1 determines whether the number of touches of the touch input is one (Step S7). As described above, it is possible for the display device 1 to detect multiple contact points and to obtain their respective operational point coordinates because the display device 1 has the multi-touch UI. Therefore, the input control unit 32 can obtain the number of touches of the touch input from the number of operational point coordinates obtained by the obtainment unit 31.

At Step S7, if the number of touches is not one (NO at Step S7), the input control unit 32 of the display device 1 determines whether the number of touches of the touch input is two (Step S8). If the number of touches is not two (NO at Step S8), which means that the number of touches is more than two, the input control unit 32 goes back to Step S4. Also, if the number of touches is two (YES at Step S8), the input control unit 32 determines that it is a command for changing the relative position of the cursor position relative to the touch position, and executes a relative position change procedure (Step S9). A concrete example of the relative position change procedure at Step S9 will be described later.

Also, at S7, if the number of touches is one (YES at Step S7), the input control unit 32 of the display device 1 determines whether the cursor is touched (Step S10). At Step S10, the input control unit 32 compares, for example, the display coordinates of the cursor with the operational point coordinates that is input by the touch, and if the operational point coordinates are equivalent to the display coordinates, determines that the cursor is touched. Note that, even if the operational point coordinates are not completely equivalent to the display coordinates, the input control unit 32 may determine that the cursor is touched as long as the operational point coordinates are included in a predetermined neighboring range of the display coordinates (around display coordinates). At Step S10, a bit of shift of the touch may be allowed because it is sufficient to determine whether the user wants to make a touch input on the cursor.

At Step S10, if determining that the cursor is touched (YES at Step S10), the input control unit of the display device 1 determines whether the touch of the touch input is a long push (Step S11). At Step S11, the input control unit 32 determines that the touch is a long push, for example, if certain operational point coordinates have been obtained for a predetermined length of time, but not limited to that.

At Step S11, if determining that the touch is a long push (YES at Step S11), the display control unit 33 of the display device 1 determines that it is a command for changing the cursor icon, and executes a cursor icon change procedure (Step S12). A concrete example of the cursor change procedure at Step S12 will be described later. If determining that the touch is not a long push (NO at Step S11), the display control unit 33 of the display device 1 goes back to Step S4.

At Step S10, if determining that the cursor is not touched (NO at Step S10), the input control unit 32 of the display device 1 sets the display coordinates with the position that has the relative distance with the operational point coordinates of the touch input (Step S13). At Step S13, the input control unit 32 obtains the relative distance from the storage unit 35, calculates the positional coordinates at which the cursor is displayed based on the operational point coordinates and the relative distance, and sets the calculated positional coordinates to the display coordinates. In this way, the cursor is displayed at the position that has the relative distance and direction relative to the operational point coordinates of the touch input.

Also, if the touch position is moved by the user with a slide operation or the like, namely if the operational point coordinates are moved, the input control unit 32 calculates positional coordinates at which the cursor is to be displayed that is the relative position of the cursor relative to the operational point coordinates of the touch input. Also, the input control unit 32 sets the calculated positional coordinates to the display coordinates. In this way, the cursor is displayed at the position that has the relative distance and direction relative to the operational point coordinates of the touch input (see, for example, FIG. 4C).

Also, at Step S4 described above, if determining that the end button is pushed down for ending the cursor operation mode (YES at Step S4), the input control unit 32 of the display device executes input control for taking the display coordinates of the cursor as the input coordinates (Step S14). Also, at Step S6 described above, if determining that the touch input is a double tap (YES at Step S6), the input control unit 32 of the display device 1 similarly executes input control for taking the display coordinates of the cursor as the input coordinates (Step S14). For example, if the user uses the cursor to make a touch operation on a button, the input control unit 32 compares the positional coordinates of the button with the input coordinates, and if the positional coordinates of the button are equivalent to the input coordinates, determines that an operation is made on the button, and executes a process for a push-button operation.

Next, the input control unit 32 of the display device 1 executes an end procedure of the cursor operation mode (Step S15). At Step S15, the input control unit 32 may not display the cursor on the touch panel if the cursor is not set to be used, for example, in usual operational states, but not limited to that.

<Example of Relative Position Change Procedure (Step S9)>

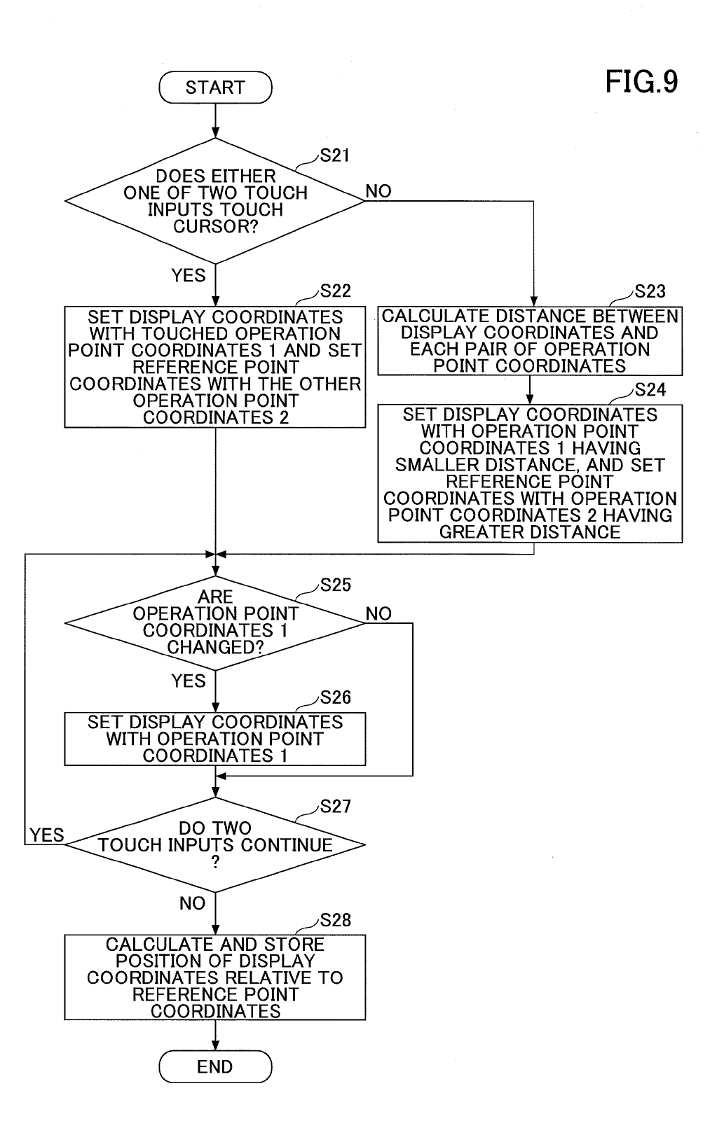

FIG. 9 is a flowchart illustrating an example of the relative position change procedure according to the present embodiment. Note that FIG. 9 is provided for describing a concrete example of the relative position change procedure at Step S9 mentioned above.

In the example in FIG. 9, the display device 1 determines whether one of the two touch inputs touches the cursor (Step S21). At Step S21, the change unit 34 of the display device 1 compares, for example, two pairs of operational point coordinates with the display coordinates of the cursor, and if either one pair of the operational point coordinates are equivalent to the display coordinates, determines that the one touch input touches the cursor. Note that the change unit 34 may determine that the one touch input touches the cursor if the operational point coordinates is included in a predetermined neighboring range of the display coordinates.

If determining that either one of the touch inputs touches the cursor (YES at Step S21), the change unit 34 of the display device 1 sets the display coordinates with the operational point coordinates of the touch input to the cursor (referred to as “operational point coordinates 1” below). Further, the change unit 34 sets the reference positional coordinates with the other operational point coordinates (referred to as “operational point coordinates 2” below) (Step S22). In this way, the cursor is displayed at the operational point coordinates 1 where the touch input touches the cursor (see, for example, FIG. 6B).

Also, if determining that neither one of the touch inputs touches the cursor (NO at Step S21), the change unit 34 of the display device 1 needs to determine which operational point coordinates should be set to the reference positional coordinates. Therefore, the change unit 34 of the display device 1 calculates the distance to the display coordinates from the respective operational point coordinates (Step S23).

Next, the change unit 34 of the display device 1 sets the display coordinates with operational point coordinates having a smaller distance (assume that it is the operational point coordinates 1), and sets the reference positional coordinates with the other operational point coordinates having a greater distance (assume that it is the operational point coordinates 2) (Step S24).

Namely, at Steps S23-S24, the operational point coordinates 2 away from the display position of the cursor is the finger A, and the operational point coordinates 1 closer to the display position of the cursor is the finger B (see, for example, FIGS. 6A-6B). In this way, the cursor is displayed at the operational point coordinates 1 that is closer to the display position of the cursor among the two operational point coordinates of the touch inputs (see, for example, FIG. 6B). Note that the reason why the operational point coordinates 1 closer to the cursor among the two operational point coordinates of the two touch inputs are taken as the finger B is to allow a bit of shift of the touch to the cursor made by the user.

After Steps S22-S24, the change unit 34 of the display device 1 determines whether the operational point coordinates 1 have been changed (Step S25). Note that the operational point coordinates 1 are the coordinates associated with the cursor among the two operational point coordinates of the two touch inputs. Therefore, if the user is going to change the relative position, the values of the operational point coordinates 1 are changed with movement of the touch position associated with the cursor (see, for example, FIG. 6C).

At Step S25, if the operational point coordinates 1 have been changed (YES at Step S25), the change unit 34 of the display device 1 sets the moved operational point coordinates 1 to the display coordinates (Step S26). Note that the display coordinates represent the display position of the cursor. Therefore, the cursor is displayed while moving along with the moving touch position (see, for example, FIG. 6C).

After S26, or, at S25 described above, if determining that the operational point coordinates 1 have not been changed (NO at Step S25), the change unit 34 of the display device 1 determines whether the two touch inputs continue (Step S27). At Step S27, the change unit 34 of the display device 1 may determine that the two touch inputs continue, for example, if the number of touches obtained by the obtainment unit 31 is two, but not limited to that.

At Step S27, if determining that the two touch inputs continue (YES at Step S27), the change unit 34 of the display device 1 determines that the relative position change operation continues, and goes back to Step S25. Also, if determining that the two touch inputs do not continue (NO at Step S27), the change unit 34 of the display device 1 calculates the relative position of the display position relative to the reference positional coordinates at this moment, and stores (overwrites and saves) the calculated relative position to the storage unit 35 or the like as the updated relative position. Note that the two touch inputs are determined as not continuing if the user lifts both of or one of the fingers A and B off the screen, but not limited to that.

According to an aspect of the relative position change procedure described above, by making a touch operation to the cursor to move the position of the cursor, the user can smoothly change the relative position of a cursor position relative to a tapped position where the touch position different from the cursor position is taken as a reference position.

<Example of Cursor Icon Change Procedure (Step S12)>

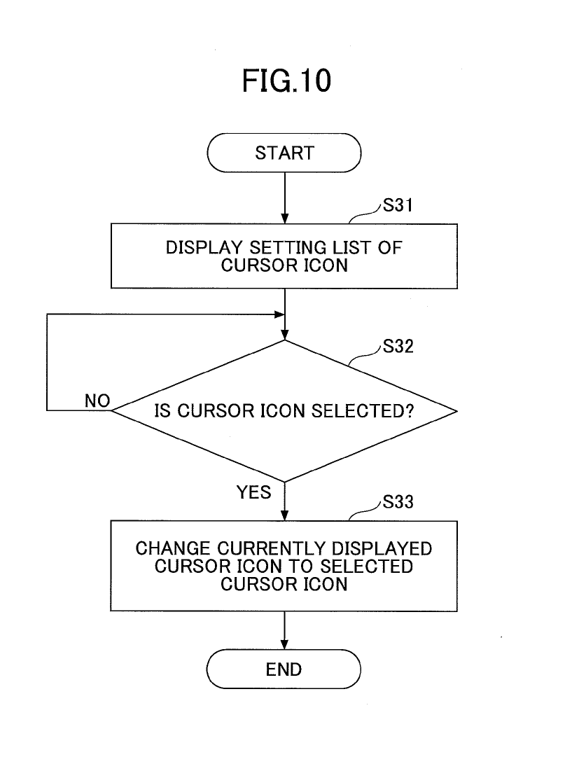

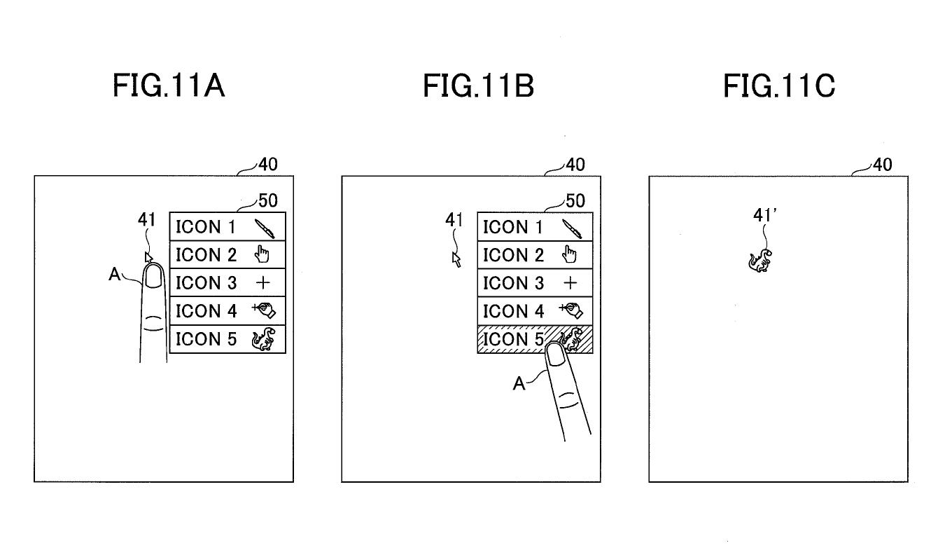

FIG. 10 is a flowchart illustrating an example of a cursor icon change procedure according to the present embodiment. Note that FIG. 10 is provided for describing a concrete example of the cursor icon change procedure at Step S12 mentioned above. Also, FIGS. 11A-11C are schematic views illustrating a state of a change of a cursor icon.

In the example in FIG. 10, the display control unit 33 of the display device 1 displays a cursor icon setting list (Step S31). At Step S31, the display control unit 33 of the display device 1 displays the cursor icon setting list 50 on the touch panel 40 (the screen of the display device 1), for example, as illustrated in FIG. 11A. The cursor icon setting list 50 includes cursor names and image information (for example, form and color) of the cursors to be displayed, but is not limited to these. Various information displayed in the cursor icon setting list 50 is stored in the storage unit 35 beforehand.

Next, the display control unit 33 of the display device 1 determines whether a cursor icon is selected in the cursor icon setting list 50 displayed as illustrated in FIG. 11A (Step S32). At Step S32, the display control unit 33 may receive a selection of a cursor icon that is made by touching the area of one of the cursor icons with a finger as illustrated in FIG. 11B, but not limited to that.

At Step S32, if determining that no icon is selected (NO at Step S32), the display control unit 33 of the display device 1 goes back to Step S32, and waits for a selection of a cursor icon. Note that the display control unit 33 of the display device 1 may end the procedure and delete the cursor icon setting list 50 on the screen if no cursor icon is selected after a certain length of time has passed since the cursor icon setting list 50 was displayed.

Also, at Step S32, if a cursor icon is selected (YES at Step S32), the display control unit of the display device 1 changes the currently displayed cursor 41 to a cursor 41′ having the selected icon as illustrated in FIG. 11C (Step S33). In the example in FIG. 11C, the cursor 41′ having the selected icon is displayed on the touch panel, but the display position is not limited to that.

According to an aspect of the cursor icon change procedure described above, a user can smoothly change a cursor icon image to be displayed by a touch operation to the cursor.

Also, according to an aspect of the present embodiment described above, a user can smoothly change the display position of a cursor relative to a touch position. Specifically, the user can smoothly change the relative position of the display position of the cursor relative to the touch position of the finger or the like. Note that although the user uses the finger to touch the screen in the embodiments described above, it is not limited to that. The user may use a pointing device such as a touch pen to touch the screen.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
an obtainment unit configured to obtain a touch position and the number of touches on a screen;
an input control unit configured to display a cursor at a relative position relative to the touch position obtained by the obtainment unit as a reference, and to control input using positional information of the cursor being displayed;
a change unit configured to switch the control executed by the input control unit if two touch positions including a first touch position and a second touch position are obtained by the obtainment unit, and to change the relative position by moving the second touch position relative to the first touch position.

2. The display device as claimed in claim 1, wherein the change unit changes a distance or a direction relative to the first touch position as a reference position, the distance or the direction being used for displaying the cursor.

3. The display device as claimed in claim 1, wherein the input control unit switches to a process for changing the relative position depending on the touch position and the number of touches obtain by the obtainment unit, or switches to a process for changing an icon of the cursor.

4. The display device as claimed in claim 1, wherein the change unit calculates a distance between the cursor position and each of the two touch positions obtained by the obtainment unit, takes one of the two touch positions having the smaller calculated distance as the second touch position, and takes the other one of the two touch positions having the greater calculated distance as the first touch position.

5. The display device as claimed in claim 3, wherein the input control unit switches to the process for changing the icon of the cursor if the number of touches obtained by the obtainment unit is one and the touch position stays at the display position of the cursor for more than a predetermined length of time.

6. The display device as claimed in claim 1, further comprising:
a display control unit configured to display a list of a plurality of cursor icons set beforehand on the screen, and to display the cursor using a cursor icon selected among the plurality of cursor icons being displayed in the process for changing the icon of the cursor.

7. An input control method executed on a display device, the method comprising:
obtaining a touch position and the number of touches on a screen;
displaying a cursor at a relative position relative to the touch position obtained by the obtaining as a reference;
controlling input using positional information of the cursor being displayed;
switching the controlling if two touch positions including a first touch position and a second touch position are obtained by the obtaining, and changing the relative position by moving the second touch position relative to the first touch position.

8. A computer-readable recording medium having a program stored therein for causing a computer to execute an input control method, the method comprising:
obtaining a touch position and the number of touches on a screen;
displaying a cursor at a relative position relative to the touch position obtained by the obtaining as a reference;
controlling input using positional information of the cursor being displayed;
switching the controlling if two touch positions including a first touch position and a second touch position are obtained by the obtaining, and changing the relative position by moving the second touch position relative to the first touch position.
